(19) United States
(12) Patent Application Publication
(10) Pub. No.: US 2021/0080155 A1
(43) Pub. Date: Mar. 18, 2021

(54) TANKLESS MAGNETIC INDUCTION WATER HEATER/CHILLER ASSEMBLY

(71) Applicant: Heat X, LLC, Auburn Hills, MI (US)

(72) Inventor: Miguel A. Linares, Bloomfield Hills, MI (US)

(21) Appl. No.: 17/021,519

(22) Filed: Sep. 15, 2020

Related U.S. Application Data
(60) Provisional application No. 62/900,755, filed on Sep. 16, 2019.

(51) Int. Cl. F25B 21/00

(52) U.S. Cl. CPC F25B 21/00; F25B 2321/0022

(57) ABSTRACT

A fluid conditioning system with a housing having a fluid inlet. A sleeve shaped support extends within the housing. A plurality of spaced apart magnetic or electromagnetic plates are communicated with the fluid inlet and extend radially from the sleeve support. An elongated conductive component arranged about the sleeve support and incorporates a plurality of linearly spaced apart and radially projecting fluid communicating packages which alternate in arrangement with the axially spaced and radially supported magnetic/electromagnetic plates. A conduit extends from the fluid inlet to a fluid outlet of the housing, each of the fluid communicating packages includes individual inlet and outlet locations to the conduit. A motor or other rotary inducing input rotates the sleeve support and magnetic/electromagnetic plates to generate an oscillating magnetic field, resulting in conditioning of the fluid circulated within each fluid communicating package by either heating or cooling of the fluid.

### CROSS REFERENCE TO RELATED APPLICATIONS

The present application claims the priority of U.S. Ser. No. 62/900,755 filed Sep. 16, 2019, the contents of which are incorporated by reference.

### FIELD OF THE INVENTION

The present invention relates generally to an electromagnetic or magnetic induction water heating/chilling assembly or magnetocaloric fluid heat pump. More specifically, the present invention discloses a magnetic induction water heater/chiller which incorporates an elongated and rotating magnet or electromagnetic array configured within a housing, a heat/chill conductive disks/plates array arranged in proximity to the rotating magnet/electromagnetic array. A fluid is communicated through the conductive array between cold/ambient inlet fluid and heated outlet locations in order to provide on demand conditioned (heated or chilled) fluid.

### BACKGROUND OF THE INVENTION

The phenomena of magnetic or electromagnetic induction heating is well known in the prior art by which heat is generated in an electrically conductive object by the generation of eddy currents, also called Joule heating. The typical induction heater includes an electronic oscillator which passes a high frequency alternating current through an electromagnet. The eddy currents flowing through the resistance of a conductive metal placed in proximity to the magnet/electromagnet in turn heat it. Put another way, the eddy currents result in a high-frequency oscillating magnetic field which causes the magnet's polarity to switch back and forth at a high-enough rate to produce heat as byproduct of friction.

One known example of a prior art induction heating system is taught by the electromagnetic induction air heater of Garza, US 2011/0215089, which includes a conductive element, a driver coupled to the conductive element, an induction element positioned close to the conductive element, and a power supply coupled to the induction element and the driver. Specifically, the driver applies an angular velocity to the rotate the conductive element around a rotational axis. The power supply provides electric current to the induction element to generate a magnetic field about the induction element such that the conductive element heats as it rotates within the magnetic field to transfer heat to warm the cold fluid flow streams. The fluid flow streams are circulated about the surface of the conductive element and directed by the moving conductive element to generate warm fluid flow streams from the conductive element.

Also referenced is the centrifugal magnetic heating device of Hsu 2013/0062340 which teaches a power receiving mechanism and a heat generator. The power receiving mechanism further includes a vane set and a transmission module. The heat generator connected with the transmission module further includes a centrifugal mechanism connected to the transmission module, a plurality of bases furnished on the centrifugal mechanism, a plurality of magnets furnished on the bases individually, and at least one conductive member corresponding in positions to the magnets. The vane set is driven by nature flows so as to drives the bases synchronically with the magnets through the transmission module, such that the magnets can rotate relative to the conductive member and thereby cause the conductive member to generate heat.

### SUMMARY OF THE PRESENT INVENTION

The present invention discloses, without limitation, an electromagnetic or magnetic tankless water heating system. The heater/chiller system is applicable to any fluid and, as will be described further, the water heater can alternatively be reconfigured as a water chiller assembly utilizing the teachings of magneto-caloric heating or cooling.

In either configuration, a housing incorporates a rotating magnet or electromagnet array including a sleeve or shaft component which can be rotatably supported and driven, such as via an electric motor or other rotary inducing input. A plurality of linearly spaced apart plates project radially from the rotatably sleeve or shaft, the plates each incorporate one or more individual magnet or electromagnet arrays. Brackets extend from the rotating magnetic array shaft or sleeve to end mounting locations within the water heater housing or cabinet.

A thermal conductive array (heating or cooling) is arranged in proximity to the rotating magnet/electromagnetic array and typically includes a plurality of annular conductive (e.g. disk) packages which alternate with the individual magnet/electromagnet arrays. The disk packages can be fixed within the interior of the housing, and are interconnected via a fluid carrying conduit extending between inlet and outlet locations of the housing so that fluid is communicated through interior pathways or channels configured within the individual thermal conductive disk packages in order to provide on demand conditioned fluid.

Upon rotation of the shaft or sleeve supported magnetic arrays relative the conductive packages, generation of magnetic frictional/oscillating fields occurs in the spaces between the opposing magnets/electromagnets and the conductive disk packages. As a result, magnetic or electromagnetic heating or cooling of the conductive disk packages occurs owing to the magnetic friction created from the oscillating fields, the intensity (and resulting heating or cooling factor) being further adjustable according to a number of parameters not limited to relative speed of rotation.

In this manner, the fluid communicated through the interior pathways or channels of each conductive disk packages are conductively heated by the heat of the friction resulting from the oscillating fields (in response to the magneto-caloric effect), owing to the inter-rotational motion between the magnetic or electromagnetic plates and the conductive packages. The fluid pathways within the individual disk packages can be arranged in series or in parallel to a common fluid carrying conduit such that the present invention accordingly provides for on-demand conditioned fluid (e.g. without limitation being hot or chilled water or other liquid or gas) without the requirement of a fluid holding tank.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of an electromagnetic or magnetic induction water heater assembly according to a first embodiment of the present invention;

FIG. 2 is a length cutaway of the water heater of FIG. 1 and illustrating a rotary supported axial extending sleeve or shaft, such including an open interior channel which can support an electric motor, any other type of motor/engine or other rotary inducing input supporting a plurality of spaced apart rotating magnetic or electromagnetic plates, along with an elongated conductive component secured within the housing and surrounding the magnetic/electromagnetic component, the conductive component including spaced packages which alternate with the magnetic/electromagnetic plates, the spaced packages each including fluid communicating pathways or channels extending about their individual circumferences and which are integrated into a fluid conduit extending between inlet and outlet locations of the housing so that, upon rotation the magnetic/electromagnetic plates (each providing the combined features of ferromagnetic or inductive magnetic or electromagnetic heating) the assembly provides on demand hot water;

FIG. 3 is an illustration taken along line 3-3 of FIG. 1 and depicting an example of a selected conductive fluid package disposed between a selected pair of rotating magnet/electromagnet arrays;

FIG. 4 is a cutaway view taken along line 4-4 of FIG. 3 and depicting a selected example of an interior pathway or channel configuration associated with a given conductive disk package for providing conductive heating of a fluid communicated between inlet and outlet locations of the disk package which are tied into the common fluid line extending between the housing inlet and outlet locations;

FIGS. 5-8 provide a succeeding series of illustrations similar to FIG. 4 showing alternate pathway configurations of a conductive disk package for heating a fluid.as it is circulated through each of the disk packages;

FIG. 9 is a perspective illustration of an electromagnetic or magnetic induction water heater assembly according to a second embodiment of the present invention;

FIG. 10 is a length cutaway of the water heater of FIG. 1 and illustrating a rotary supported axial extending sleeve or shaft, such including an open interior channel which can support an electric motor or other rotary inducing input positioned outside of the housing and which in turn rotates the plurality of spaced apart rotating magnetic or electromagnetic plates, along with an elongated conductive component secured within the housing and surrounding the magnetic/electromagnetic component, the conductive component including spaced packages which alternate with the magnetic/electromagnetic plates, the spaced packages each including a reconfigured pair of disk packages which can be configured in either series or in parallel to define a scalable/stacked array, with each subset pairs of fluid conductive disks depicted in a separate module further having fluid communicating pathways or channels extending about their individual circumferences and which are integrated into a fluid conduit extending between inlet and outlet locations of the housing so that, upon rotation the magnetic/electromagnetic plates (each providing the combined features of ferromagnetic or inductive magnetic or electromagnetic heating) the assembly provides on demand hot water;

FIG. 11 is an illustration taken along line 11-11 of FIG. 10 and depicting an example of a selected conductive fluid package including a pair of conductive plates with counter fluid directed passageways and which are disposed between a selected pair of rotating magnet/electromagnet arrays;

FIG. 12 is an exploded view of a stacked subset array of the pair of conducting plates of FIG. 11 and depicting by non-limiting example an interior pathway or channel configuration associated with a given conductive disk package for providing conductive heating of a fluid communicated between inlet and outlet locations of the disk package which are tied into the common fluid line extending between the housing inlet and outlet locations and including counter directional fluid flow between the first and second stacked conductive plates with intermediate separation component; and

FIGS. 13-15 provide a further succeeding series of illustrations showing alternate pathway configurations of a conductive disk package for heating fluids circulated through each of the disk packages.

### DETAILED DESCRIPTION OF THE PREFERRED EMBODIMENTS

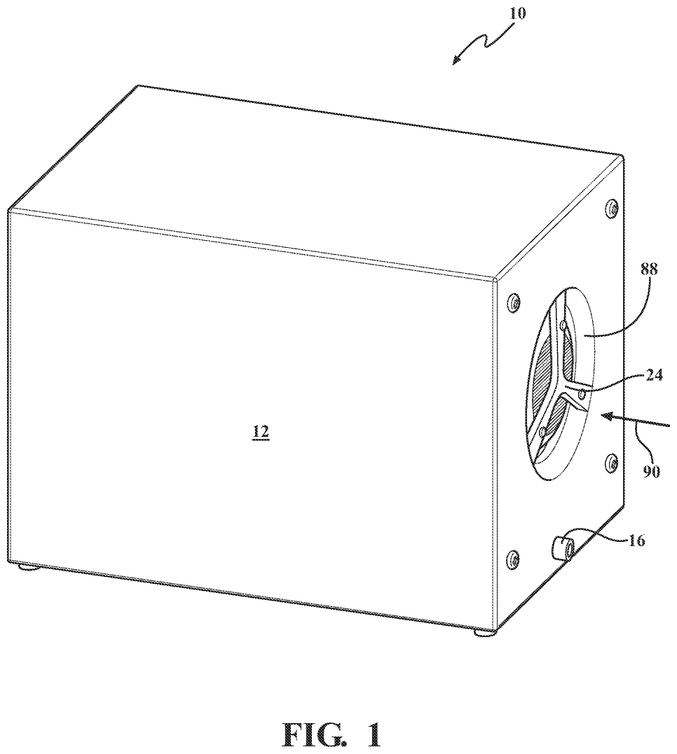

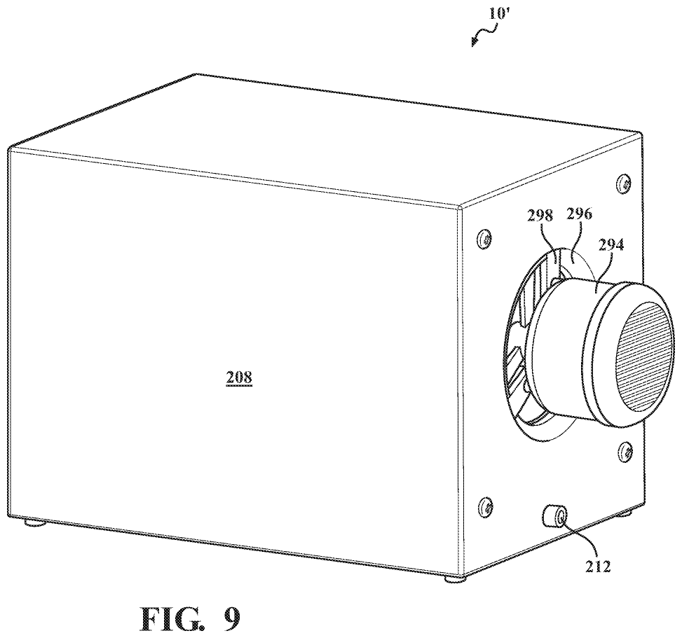

With reference to the attached illustrations, the present invention discloses, in one non-limited application, either of magnetic or electromagnetic induction water heaters, examples of which are illustrated at 10 in FIG. 1 and further at 10′ in FIG. 9. For purposes of clarity of description, the detailed description will describe as follows elements associated with a magnetic induction water heater, it being further understood that reference to the conductive heating elements in the present description are readily interchangeable to described a suitable chiller assembly in potential alternate variants, such relying on utilizing any of a magneto caloric heat pump, active magnetic regenerator, magnetic/magnetocaloric refrigerator, or magnetic/electromagnetic air conditioner (in the instance in which air is the circulated fluid).

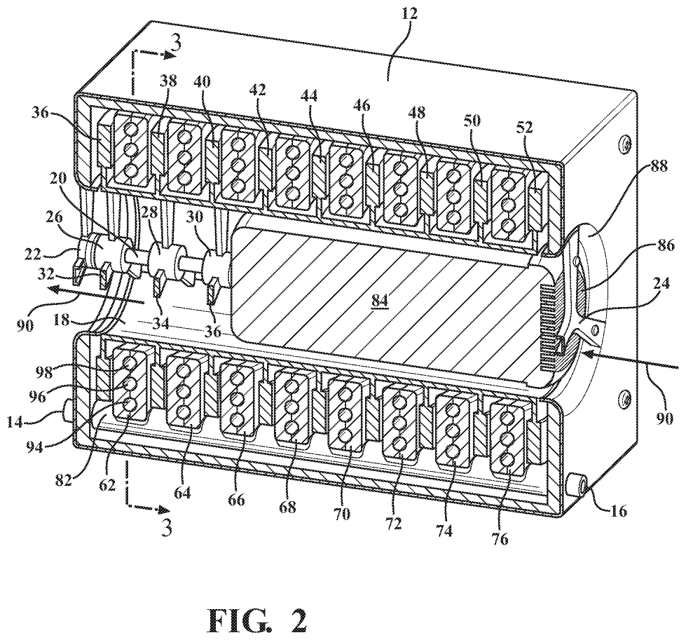

In combination with FIG. 1, FIG. 2 depicts a lengthwise perspective cutaway of the electromagnetic induction water heater/chiller and which can include any type of housing, such as rectangular three dimensional shaped cabinet 12 within which is defined an ambient or cold fluid inlet 14 (typically a liquid such as water but also envisioning other fluids not limited to glycols or other liquid/gaseous compositions). Also depicted at 16 is a hot (or alternatively chilled) outlet for delivery of the heated fluid following its circulation through the conductive disk packages as will be described in further detail.

A central sleeve 18 is supported in rotatable fashion within a length extending interior of the housing 10. As further depicted in FIG. 2, and by non-limiting example, a shaft 20 extends through a central length interior of the sleeve 18 and is in turn secured by brackets 22 and 24 associated with first and second ends of the housing. In the illustrated embodiment, a plurality of individual radial extending and rotatable bearings 26, 28, 30, et seq., are supported at length spaced locations of the central shaft, individual pluralities of radial projecting struts (see as shown at 32, 34, 36, et seq. for selected bearings 26, 28, 30, et seq.) extending from the bearings and securing to the inside circumferential surfaces of the sleeve 18. Without limitation, the present invention further additionally contemplates either the sleeve 18 or inner coaxial shaft 20 provided exclusive of the other.

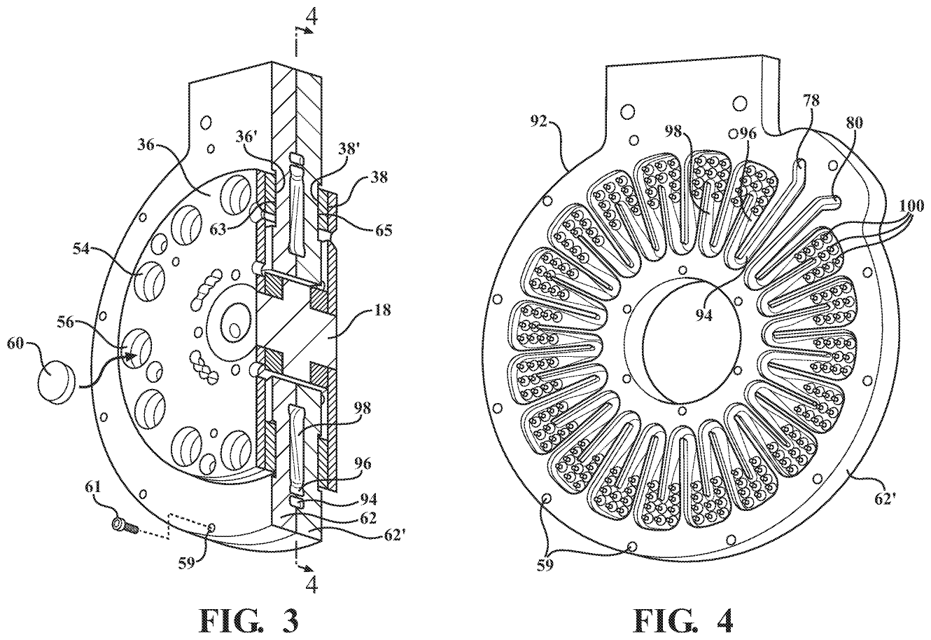

A plurality of spaced magnetic or electromagnetic plates are depicted in one non-limiting arrangement at 36, 38, 40, 42, 44, 46, 48, 50 and 52, arranged in axially spaced apart fashion and extending radially outwardly from the central sleeve 18. As further depicted in the cutaway view of FIG. 3, the individual magnetic plates (see plate 36) can include individual pockets (see at 54, 56, 58, et seq.) arranged in circumferential array and within which can be contained any of individual magnets or electromagnets (see as generally represented at 60). Without limitation, the magnetic plates 36-52 can also be constructed of a solid magnetic material or can integrate any of a variety of rare earth or electromagnetic components arranged in any configuration within and around the circumference of the individual plates.

An elongated conductive component (also partially depicted in cutaway) includes an elongated body supported (typically stationary) about the sleeve 18 and between the linearly spaced and radially projecting magnetic or electromagnetic plates 36-52. The conductive component depicts a plurality of circumferentially extending (typically disk shaped) fluid communicating packages, these depicted at 62, 64, 66, 68, 70, 72, 74 and 76 arranged in alternating fashion with the rotating magnet/electromagnetic plates 36-52. It is understood that the conductive packages can be constructed in two pieces and are welded or otherwise joined together in order to align the interior passageways (see as described below).

With subsequent reference to FIGS. 4-8, the individual conductive packages can incorporate any unique configuration of interior channel or pathway for circulating the fluid, such as according to any serpentine fashion within and along an overall circumferential pattern between individual inlet and outlet locations (see at 78 and 80 for selected disk package 62 in FIG. 4). A common fluid conduit 82 (again FIG. 2) extends between the fluid inlet 14 and outlet 16 and can be in individual communication with each interior pathway associated with each conductive package. Without limitation, it is also envisioned that the conductive packages can be tied together in parallel to the common fluid conduit 82 to provide a ready supply of on demand hot or chilled water or other fluid, and can alternatively be communicated in series to optimize heating/chilling of fluid by prolonging the exposure of the fluid to the magnetized conductive plates if heated or demagnetized conductive plates cooled/chilled.

An electric motor 84 or like rotational inducing component is provided and can include without limitation any type of blower motor, other electrical motor or generator, or any other type of motor-engine or other rotary inducing input. As further shown in FIG. 2, the motor 34 can be supported within the open interior surrounded by the cylinder 18 (see further including ventilated end location 86 positioned proximate an open side location 88 for cooling the motor via an airflow which can pass in the direction of arrows 90 through the interior of the housing 12 and so that the motor drives the interior shaft 20 to rotate the magnetic sleeve 18 and plates 36-52 relative to the alternating and close proximity spaced fluid circulating conductive packages 62-76 according to a given rotational speed.

In this fashion, the varying magnetic fields are generated via the rotation of the magnetic/electromagnetic plates to inductive heat (according to the illustrated embodiment) the space between the magnetic or electromagnetic plates and the conductive packages, owing to the alternating fields generated by the rotation of the proximate located magnets/electromagnets to frictionally heat and include eddy currents that travel in the conductive plates packages and dissipate in form of heat losses that conductively heat the fluid circulating in the packages. Associated thermostat controls can be utilized in order to cycle the motor 84 on periodically in order to keep the plates constantly warm (or chilled in an optional magneto caloric heat pump variant), such further optionally occurring without necessarily having fluid flowing through the conductive fluid heating packages.

Without limitation, the configuration and material selection for each of the magnetic or electromagnetic plates 36-52 can be selected from any material not limited to rare earth metals and alloys and which possesses properties necessary to generate adequate oscillating magnetic fields for inducing magnetic or electromagnetic heating, such again resulting from the ability to either maintain or switch the magnet polarity at a sufficiently high rate in order for the generated friction to create the desired heat/cold profile. The conductive fluid communicating packages 62-76 can be constructed, without limitation, of a ferromagnetic, paramagnetic or diamagnetic material and respond to the oscillating fields generated via magnetic induction such that they create eddy currents and Joule heating.

FIG. 3 is a cutaway illustration taken along line 3-3 of FIG. 1 and depicting an example of selected conductive fluid package 62 disposed between selected pair of rotating magnet/electromagnet arrays 36 and 38. In combination with the cutaway view of FIG. 4, a continuous interior channel or pathway is illustrated for communicating fluid such as a water source supplied under pressure through the inlet 14 depicted in FIG. 2 and progressively through the common fluid line 82 (this further again communicated by the inlet 78 and outlet 80 in FIG. 4 which is associated with the given disk package 62).

FIG. 4 depicts a cutaway view taken along line 4-4 of FIG. 3 and illustrates a selected example of an interior pathway or channel configuration associated with given conductive disk package 62, such further having an inner annular surface 92 surrounding and spaced an incremental distance from the rotating magnetic component sleeve 18 as well as having an outer peripheral surface which can be mounted to an inside of the water heater housing 12 as best shown in FIG. 2. Each conductive package, according to one non-limiting variant, further includes a pair of sandwiching plates, theses shown again in FIGS. 3 at 62 and 62′ which, following their interior opposing faces being milled or otherwise, machined to exhibit the desired interior pathway, are assembled together such as without limitation through the use of either conventional welding techniques as well as aligning apertures 59 and inserting bolt fasteners 61 in the manner generally depicted in FIG. 3. Suitable gaskets or other sealing components can be established about the inner and outer circumferential edges of the sandwiched conductive element plates (e.g. again at 62/62′) in order to prevent leakage of the circulated fluid.

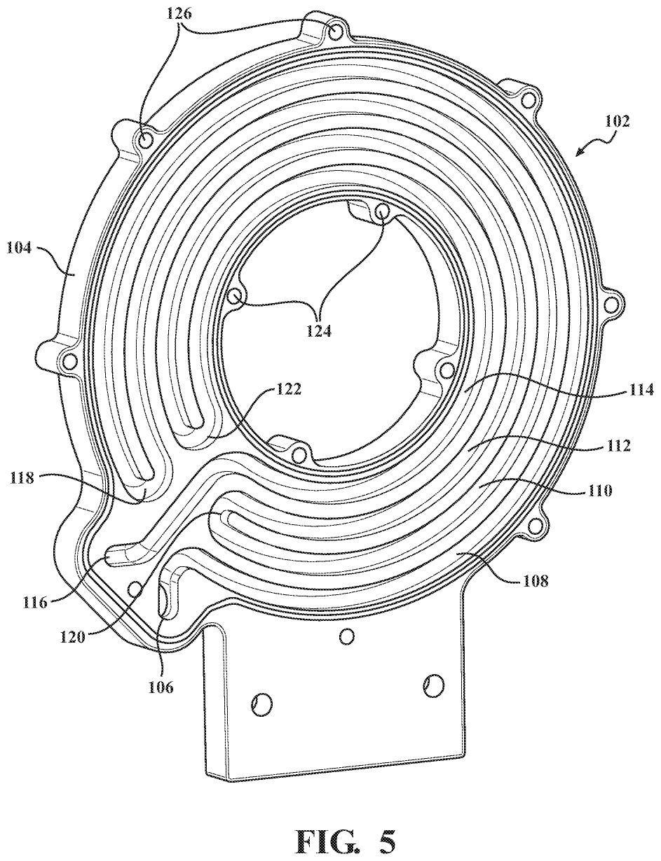

The conductive disk package provides conditioning of the fluid (such as heating or chilling depending upon the variant) communicated between the inlet 78 and outlet 80 locations of the disk package which are tied into the common fluid line 82 extending between the housing inlet 14 and outlet 16 locations. In combination with the cutaway views of FIGS. 2 and 3, each disk package 62-76 (with additional reference to each of the alternating variants in succeeding FIGS. 5-8) depicts an interior flow pathway which is configured to maximize exposure of the interior circulating fluid within the heated conductive packages during transit within the selected disk package.

As further shown, the non-limiting example of the interior fluid pathway configuration is shown in various orientations in each of FIGS. 2-4 and can include a plurality of interconnected and reverse bended radial pathways, these depicted at 94, 96, 98, et seq., and extending progressively about the circumferential interior of the disk package between the inlet 78 and outlet ends 80. In order to enhance thermal transfer from the conductive disk packages (such as via further convection into the fluid pathways from the heated or chilled conductive plates 62/62′), additional agitating or throttling elements can be designed into the interior communicating pathways which, in FIG. 4, are depicted as projecting or dimpled elements 100. Without limitation, the dimpled elements can be reconfigured in any fashion desired and can alternatively include concave or convex shapes or other profiles which serve to further slow or otherwise interrupt the fluid flow patterns within each of the intersecting pathways in order to further enhance thermal transfer from the conductive disk packages to the interiorly circulating fluid.

It is further noted, without limitation, that the invention contemplates in one non-limiting embodiment having all of the conductive packages concurrently circulating and heating/chilling fluid from the common line 82 in order to provide a steady and pressurized flow of conditioned fluid through the outlet 16. Additional non-limiting variants further envision the ability to utilize appropriate valves or controls in order to selectively activate/deactivate fluid flow through some or all of the disk packages in order to modify the volume of conditioned fluid being delivered from the water heater/chiller assembly 10, such further contemplating engaging or disengaging the rotation of the magnetic plates if the disk packages are active or inactive and connecting or disconnecting an electric supply, as well as varying intensity by increasing or decreasing power supply to the electromagnets of the disk packages that are active and engaged, if electromagnets are used, via the motor or other rotary inducing input RPM or rotational speed to accomplish best performance in terms of efficiency or COP (coefficient of performance). It is also envisioned that the associated valving/controls can be further designed in order to successively pass conditioned fluid through multiple (including consecutive or non-consecutive) conductive disk packages, such as in order to modify a desired fluid delivery temperature.

Referencing again FIG. 3, the inter-rotational interface established between the conductive packages (again depicted by a selected pair of sandwiched plates 62/62′) and the rotating magnetic/electromagnetic plates (again at 36) can also include any desired notched interface, such as shown by annular outer projection 36′ of the plate 36 as well as annular outer projection 38′ for plate 38, these seating within an annular recess profile configured within an opposite side of each conductive plate (see at 63 for plate 62 and at 65 for plate 62′). The purpose of establishing multiple planar overlapping surfaces at the inter-rotational interface between the rotating plates and conductive packages provides for increased conductive thermal transfer zones into the conductive disk packages, as well as assists in better maintaining alignment between the various components such as through providing built in bearing surface locations in the event of any misalignments during rotational driving of the magnetic sleeve 18 and the various assembled package plate subassemblies 36-52.

Given the above description, the present invention additionally envisions numerous techniques, teachings and factors for modifying the temperature range of heating/cooling or which can be accomplished for the variants described herein. This can include modifying the rotational speed (such as measured in RPM's or revolutions per minute) of the magnetic plates, thereby affecting the magnetic or electromagnetic induction (magnetic field created) and, consequently, adjusting the eddy currents created in the conductive disk packagers (sandwiched plates with interior fluid carrying pathways). With higher rotation the oscillating high frequencies of the magnetic/electromagnetic induction increases the temperature in the case of heating and also creates higher demagnetization forces (once the magnetic/electromagnetic induction is “off”) that can absorb more heat if exposed to a fluid flow (in the case of inductive cooling).

With reference to FIGS. 5-8, a succeeding series of illustrations are provided, similar to FIG. 4, and showing non-limiting examples of alternate pathway configurations of conductive disk packages for thermally conditioning a fluid. as it is circulated through each of the disk packages. With reference to FIG. 5, a first example is generally depicted at 102 of a selected half-milled, die casted, sinterized or router machined conductive plate 104 (such being known in the relevant art utilizing suitable computer numerically controlled equipment and techniques) associated with a non-limiting example of an alternate fluid pathway configuration. For purpose of each of FIGS. 5-8, each half-plate depicted is alternate to that depicted at 62′ in FIG. 4 so that discussion will be limited to the specific interior extending profile or configuration for maximizing exposure of the circulating fluid to the thermally conditioning interior of the conductive plate.

In the example of FIG. 5, the plate 104 depicts another non-limiting design of interior pathway for thermally conditioning (heating or chilling) the fluid in the form of a series of circumferentially winding, interconnected and diametrically narrowing profiles extending from inlet 106 and shown at 108, 110, 112 and 114 extending to outlet 116. As further shown, a series of hairpin bends 118, 120 and 122 are configured between the succeeding winding profiles. Also depicted are inner mounting apertures 124 and outer mounting apertures 126 associated with the cutaway plate 104 and for sandwiching and joining together (see again bolts 61 in FIG. 3) in sealed fashion consistent with that shown for conductive package 62/62′ in FIG. 3. To this end, additional sealing gaskets can again be provided about the inner and outer circumferential edges of the matching plates in order to prevent leakage of fluid into the interior of the housing 12.

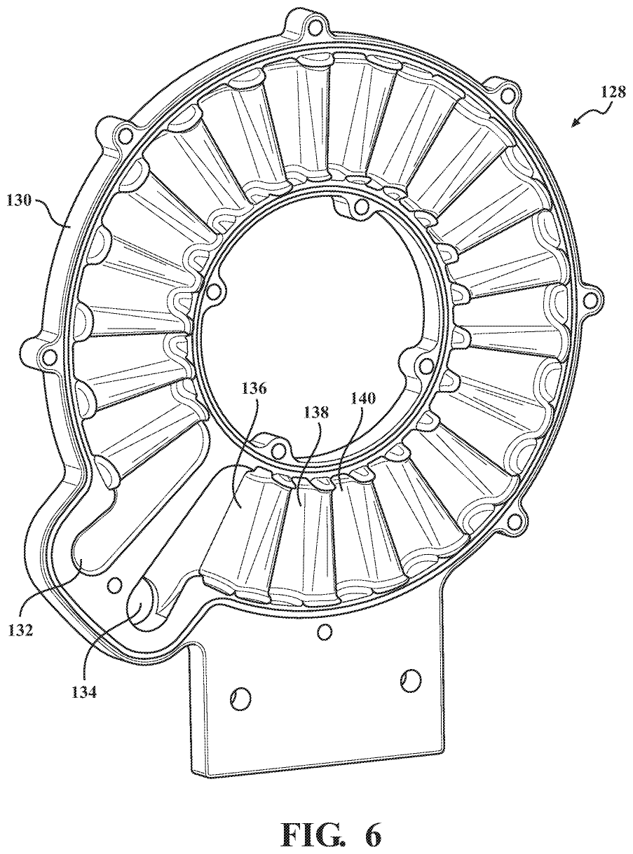

FIG. 6 depicts, generally at 128, another example of a thermal conductive disk package integrated into the present water heater/chiller system, which is referenced by half plate 130 with inlet 132 and outlet 134 in communication with the common fluid line 82 extending within the housing. The interior pathway configured within the disk package includes a plurality of radial extending and end to end interconnecting water wave ribbon profiles, these depicted at 136, 138, 140, et seq. and extending in radially and angled/tapered fashion about the disk shaped circumference of the package interior. In this fashion, the circulating fluid is caused to reverse angle between each succeeding water wave ribbon, in combination with being throttled or agitated in order to slow the circulatory flow for achieving a more complete thermal treated profile to a desired temperature.

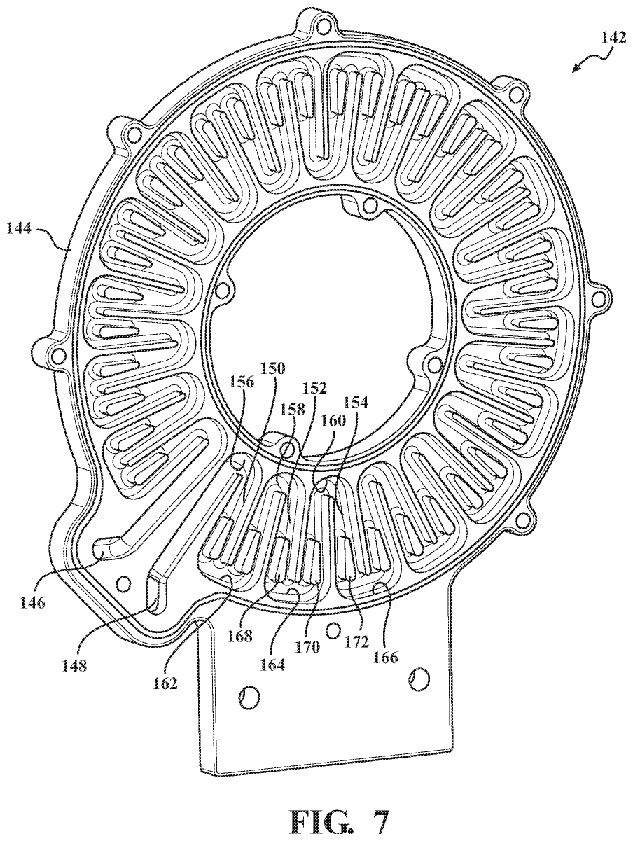

FIG. 7 provides a further depiction generally at 142 of a sectioned conductive plate 144 having inlet 146 and outlet 148 locations. The winding interior pathway is further reconfigured as a plurality of reverse angled and radially winding water tubes 150, 152, 154, et seq. provided in end to end connecting fashion and progressively circumferentially extending about the annular interior of the disk package. Similar to the depiction in FIG. 4, the variant of the reverse winding patter in FIG. 7 includes each of inner radial end profiles 156, 158, 160, et seq., which are shown for each water tube and include rounded elbows in combination with widened outer radial end profiles, further shown at 162, 164, 166, et seq. Also shown are tapered projections 168, 170, 172, et seq. positioned within each radial channel in order to further disrupt fluid flow as it winds its way through the interior of the package and in order to slow/agitate the same and to allow for more complete conductive heating before being communicated through the outlet 148.

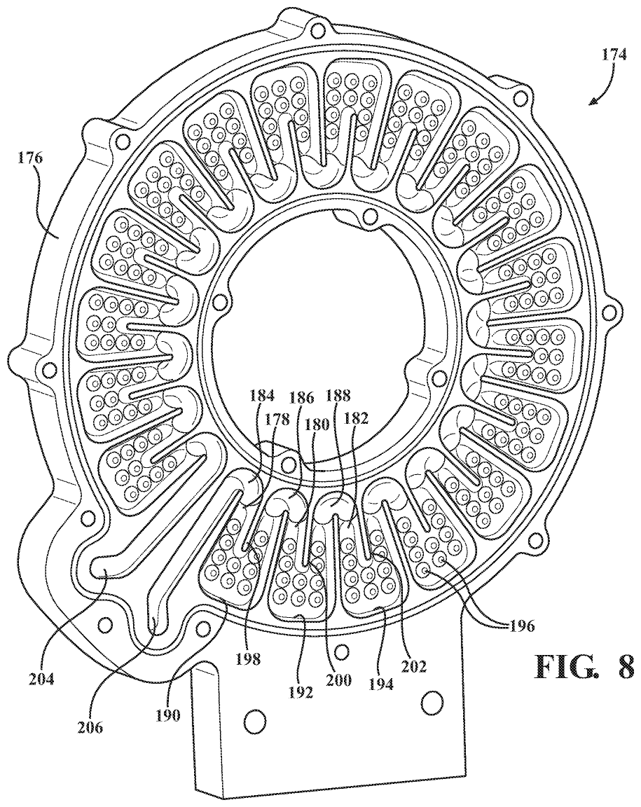

FIG. 8 illustrates a still further example, generally at 174, of a sectional view of a conductive plate 176 with a similar configuration of radial and winding reverse/angled pathways 178, 180, 182, et seq. similar to the patterns depicted in the examples of each of FIGS. 4 and 7 and including both elbowed inner radial end profiles 184, 186, 188, et seq, and outer widened end flattened profiles 190, 192, 194, et seq. Additional dimpled elements 196 (similar to those previously depicted at 100 in FIG. 4) are distributed within the open pockets associated with each succeeding pairs of reverse-bended profiles in order to provide for the desired agitation/slowing of the circulating fluid flow to enhance thermal conditioning of the fluid. As further shown, the reverse angled bends defining the interior pathways are further facilitated by partially outwardly radial barriers 198, 200, 202, et seq. which extend within each interior pocket in order to assist in redirecting the fluid flow in the desired progressive and reverse bended fashion in the combined radial and circumferential progressing fashion within the conductive heated or cooled package interior between inlet 204 and outlet 206 locations.

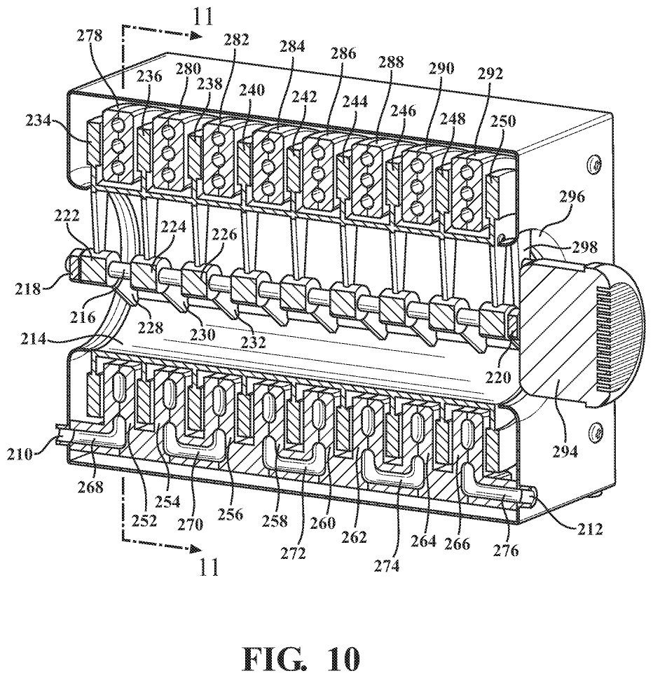

With further reference to FIG. 9, a perspective view is generally shown at 10′ of an electromagnetic or magnetic induction water heater assembly according to a second embodiment of the present invention as compared to that previously depicted at 10 in FIG. 1. FIG. 10 depicts a lengthwise perspective cutaway of the electromagnetic induction water heater/chiller and which again can include any type of housing, such as rectangular three dimensional shaped cabinet 208 within which is defined an ambient or cold fluid inlet, see again in combination at 210 in FIG. 10 and including any liquid such as water but also envisioning other fluids not limited to glycols or other liquid/gaseous compositions. Also depicted at 212 is a hot (or alternatively chilled) outlet for delivery of the heated fluid following its circulation through the conductive disk packages as will be described in further detail.

As further depicted in the length cutaway of FIG. 10, a central sleeve 214 is supported in rotatable fashion within a length extending interior of the housing 10′. Shaft 216 extends through a central length interior of the sleeve 214 and is in turn secured by brackets 218 and 220 associated with first and second ends of the housing.

As with the previously described embodiment in FIG. 2, a plurality of individual radial extending and rotatable bearings 222, 224, 226, et seq., are supported at length spaced locations of the central shaft, with individual pluralities of radial projecting struts 228, 230, 232, et. seq. for selected bearings 222, 224, 226, et. seq. extending from the bearings and securing to the inside circumferential surfaces of the sleeve 18. As in the first embodiment, and without limitation, the present invention further additionally contemplates either the sleeve 214 or inner coaxial shaft 216 provided exclusive of the other.

A plurality of spaced magnetic or electromagnetic plates are depicted in one non-limiting arrangement at 234, 236, 238, 240, 242, 244, 246, 248, and 250, arranged in axially spaced apart fashion and extending radially outwardly from the central sleeve 214. As previously described in reference to the cutaway view of FIG. 3 for the first embodiment, the individual magnetic plates each include individual pockets arranged in circumferential array and within which can be contained any of individual magnets or electromagnets. Without limitation, the magnetic plates 234-250 can again also be constructed of a solid magnetic material or can integrate any of a variety of rare earth or electromagnetic components arranged in any configuration within and around the circumference of the individual plates.

An elongated conductive component (also partially depicted in cutaway) is again provided (similar to the first variant) and includes an elongated body supported (typically stationary) about the sleeve 214 and between the linearly spaced and radially projecting magnetic or electromagnetic plates 234-250. The conductive component depicts a plurality of circumferentially extending (typically disk shaped) fluid communicating packages, these depicted in cutaway in FIG. 10 by lower profile packaged plate shaped sections 252-266, of which these can be combined in paired fashion so that the are arranged alternating with the rotating magnet/electromagnetic plates 234-250.

A cross sectional cutaway of the individual disk packages, such as previously described in reference to FIGS. 4-8, would include depict any type of interior pathway associated with the conductive package elements and which would provide for any unique configuration of interior channel or pathway for circulating the fluid. This can again be provided in any serpentine fashion extending within and along an overall circumferential pattern between individual inlet and outlet locations of each conductive package relative to a common fluid conduit (see interconnected conduit locations 268, 270, 272, 274 and 276 in FIG. 10 extending between the fluid inlet 210 and outlet 212).

The conduit sub-sections 268-276 can, without limitation, be in communication with each interior pathway (or pair of interior pathways) associated with each conductive package or pair of disk packages 254/256, 258/260, 262/264. Without limitation, it is also envisioned that the conductive packages can be tied together in parallel to the common fluid conduit (or subsections thereof) to provide a ready supply of on demand hot or chilled water or other fluid, and can alternatively be communicated in series to optimize heating/chilling of fluid by prolonging the exposure of the fluid to the heated conductive plates.

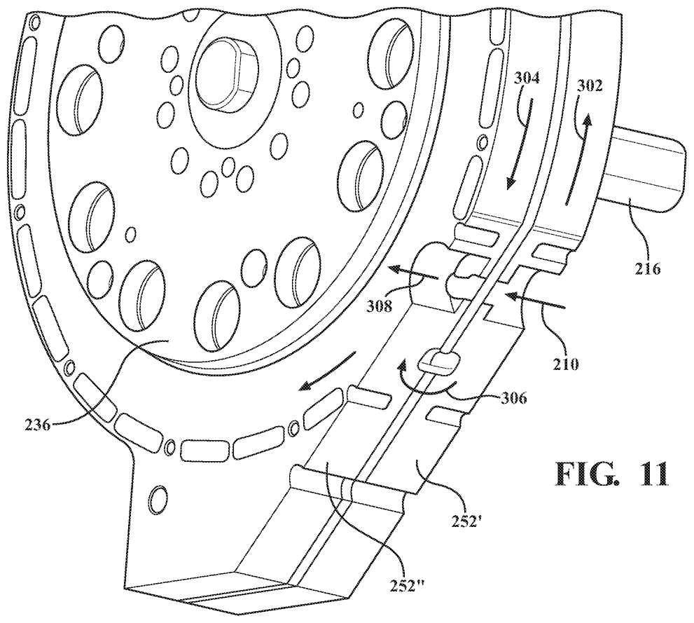

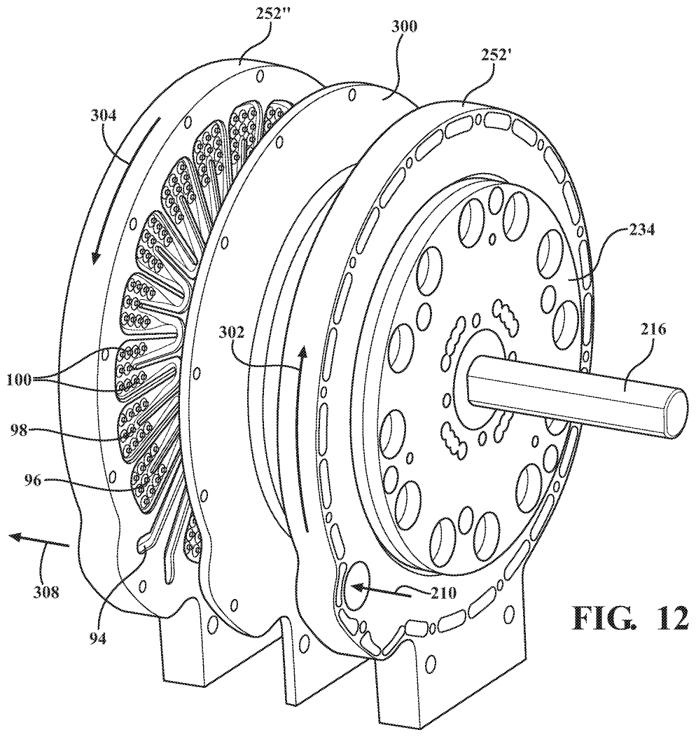

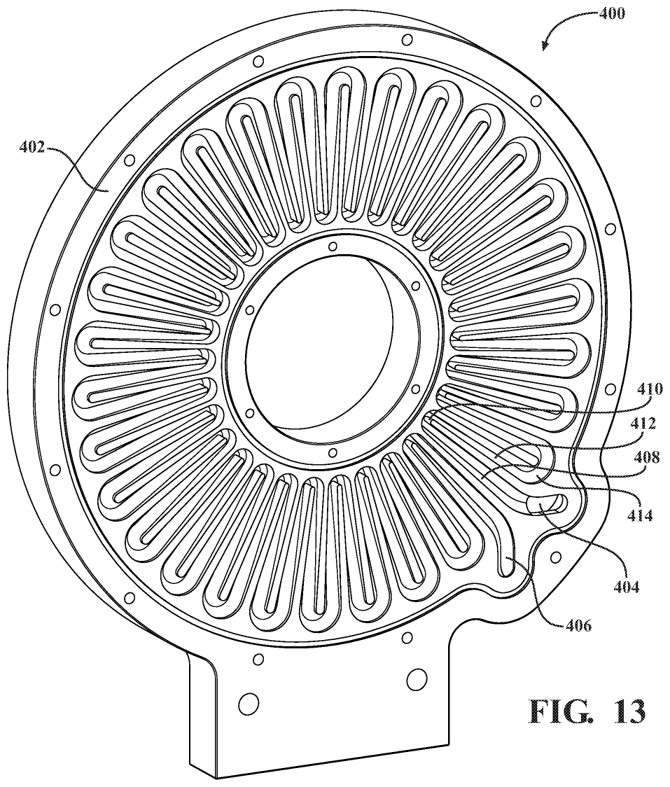

The conduit sections can also include standardized circumferential locations which mirror those depicted at 278, 280, 282, 284, 286, 288, 290 and 292, these envisioned to be merged into the individual lower subsection configurations shown at 252-266 respectively and so that each disk package depicts a pair of sandwiched and inter-affixed plates which may have been previously milled or bored in order to establish the desired interior pathway configuration and, as will be further described with reference to FIGS. 11-12, provided as individual pairs of stacked conductive plates which provide first and second (counter-directional) circumferential fluid conductive pathways provided in order to maximize heat transfer to the circulated fluid.

An electric motor 294 or like rotational inducing component is provided and can include without limitation any type of blower motor, other electrical motor or generator. In contrast to the interiorly supported variant in FIG. 2 which is depicted by the motor 34, the reconfigured motor 294 in FIG. 10 can be supported outside of the cylinder 214 and associated cabinet body 208.

Similar to FIG. 10, a ventilated end location 296 positioned proximate an open side location of the housing can again provide for a cooling airflow to the motor (such further facilitated by bracket supports 298 for securing to an end location of the cabinet housing) and so that the motor drives the interior shaft 216 to rotate the magnetic sleeve 214 and plates 234-250 relative to the alternating and close proximity spaced fluid circulating conductive packages 268-276 according to a given rotational speed.

FIG. 11 is an illustration taken along line 11-11 of FIG. 10 and depicting an example of a selected conductive fluid package 252 including a pair of conductive plates 252′/252″ with counter fluid directed passageways and which are disposed between a selected pair of rotating magnet/electromagnet arrays. Similar to the arrangement depicted in FIG. 3, the individual pairs or conductive disks are located between spaced magnetic plates (see selected plate 236 on back side of stacked conductive plate 252″), these each including pockets similar to those shown at 54, 56, 58, et seq. in FIG. 3 for receiving individual magnets/electromagnets. The travel direction of the fluid is depicted by directional arrows 302 and 304 for conductive plates 252′/252″, with interface transfer location further shown at 306 and outlet at 308.

Proceeding to FIG. 12, an exploded view is shown of the stacked subset array of the pair of conducting plates 252′/252″ of FIG. 11 and depicting by non-limiting example an interior pathway or channel configuration associated with a given conductive disk package for providing conductive heating of a fluid communicated between inlet and outlet locations of the disk package which are tied into the common fluid line extending between the housing inlet and outlet locations and including counter directional fluid flow between the first and second stacked conductive plates with intermediate separation component. This is depicted by a first clockwise fluid pathway depicted by sub-plate 252′ with a counter clockwise pathway further depicted by inter-attached sub-plate 252″.

In operation, the conduit inlet 210 circulates the fluid (air/liquid) in a circuitous and progressively circumferential fashion similar to that shown by pathways likewise depicted in FIG. 4 and can include pathways at 94, 96, 98, et seq., in FIG. 12 in addition to dimpled projections 100 which can facilitate agitation/slowing of the circuitous fluid flow in order to maximize heat transfer. An intermediate plate 300 is shown in exploded fashion in FIG. 12 which is positioned between the sub-plates 252′/252″ and which operates to separate the individual fluid flow (clockwise about plate 252′ and, subsequently, counter clockwise about plate 252″). Although not clearly shown, the intermediate late 300 can include suitable apertures or pathways for redirecting the flow from an outlet location of the first sub-plate 252′ to the counter-clockwise direction established within the second sub-plate 252″. Alternatively, and without limitation the fluid flows in each sub-plate 252′/252″ can be in a similar direction.

In this manner, the individual stacked plates 252′/252″ provide scalable sub-assemblies within each of the overall stacked pairs of arrays previously identified in FIGS. 10 at 252, 254,256, 258, 260, 262, 264, and 266. Without limitation, the individual pairs of plates can be arranged in either series or parallel so that they can be scaled according to any plurality along with operation of the motor 294 and associated fluid valving arranged with respect to the various subset fluid inlets and outlets associated with each individual pair of plates (e.g. 252′/252″) extending from the common internal conduit and so that, by merely opening and closing given subset paired disk packages, the associated valving structure can vary both the flow volume and output temperature of the delivered fluid. Concurrently, appropriate slip coupling configurations integrated into the shaft (either at 20 in FIG. 2 or at 216 in FIG. 10) can allow the associated motor to selectively deactivate given sections of the magnetic rotary plates adjoining non-circulating disk packages.

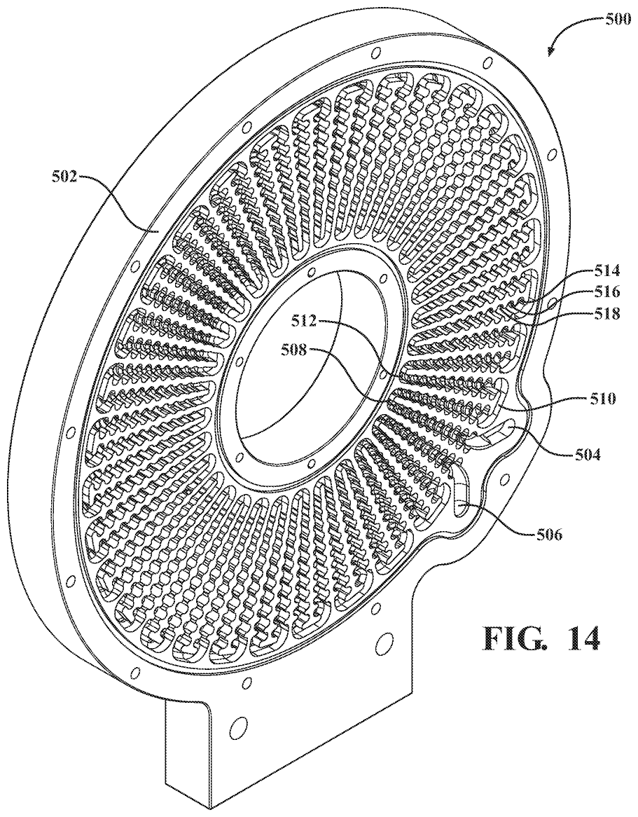

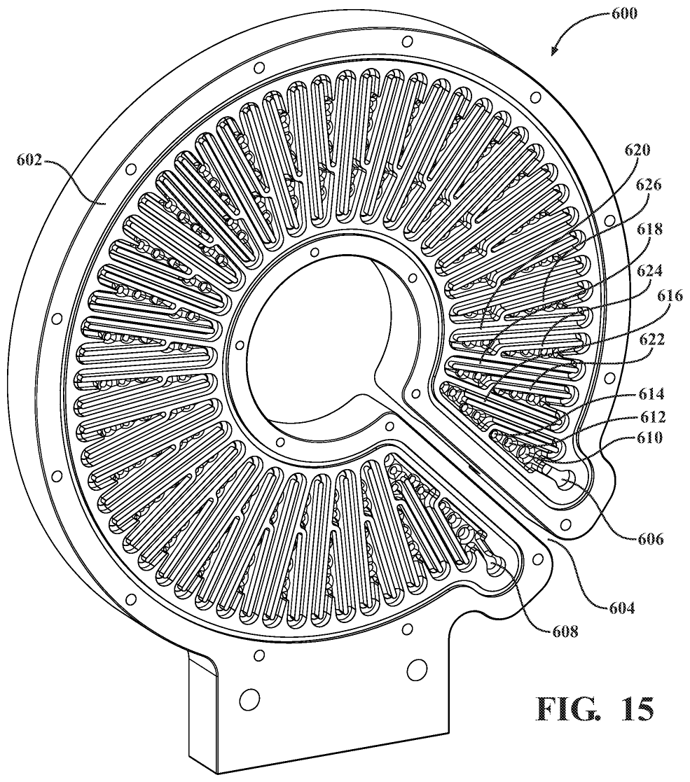

Proceeding to FIGS. 13-15, provided are a further succeeding series of cutaway illustrations showing alternate pathway configurations of a conductive disk package for heating a fluid as it is circulated through each of the disk packages. In succession, FIG. 13 depicts (generally at 400) a heater representation, with FIG. 14 providing a representation of a representation (generally at 500) of a pulse runner heater representation and, finally, FIG. 15 depicting a likewise cutaway representation (generally at 600) of a split heater representation.

Referring first to FIG. 13, a selected interior pathway is shown of a one-half component associated with a conductive disc package. As with the corresponding examples depicted in preceding FIGS. 4-8, the one-half component shown includes an inner annular surface 402. An arrangement of reverse-bended radial extending and recessed pathways is shown between an inlet 404 and outlet 406 in a progressive hairpin and winding ribbon pattern extending across the inner circumference of the disk package half and includes each of individual interconnected length 408, inner corner 410, outer reverse bended length 412, outer corner 414, and so on extending in repetitive fashion between the inlet and outlet locations. As previously described, an opposing the mating second half plate is assembled against that shown at 400, such as again through the use of appropriate gaskets and mounting fasteners or the like.

Proceeding to FIG. 14, the alternate half disk package 500 is again shown and includes a similar annular inner face 502 configured with a suitable dimpled or irregular pattern extending between each of inlet 504 and outlet 506 locations. Similar to that shown in FIG. 13, the interior network is provided by a plurality of radial and reverse-bended locations (see at 508, 510, 512, et seq.) extending in progressing fashion about the interior perimeter of the selected ½ disk package.

As further shown, a plurality of individual throttling or agitating elements are depicted (examples of these being shown at 514, 516, 518, et seq.,) which construct reverse bended pathways. As previously described, and without limitation, the dimpled elements can be reconfigured in any fashion desired and can again include any of convex or concave shapes for or other profiles for adapting the fluid flow within the disk package as desired in order to throttle and adjust fluid flow within each of the intersecting pathways in order to enhance thermal transfer from the conductive disk packages to the interiorly circulating fluid.

FIG. 15 illustrates, generally at 600, a one-half conductive package section exhibiting a split configuration of a milled interior profile associated with each sandwich assembled package or unit. As with the examples of FIGS. 14-15, an inside annular surface 602 of the one-half disk package can include a radially split location 604, separating an inlet 606 from an outlet 608.

A variant of the pathway network depicted in previous embodiments includes an alternating combinations of dimples (see individual pluralities of dimples 610/612/614) at distributed locations across the conductive plate. The dimple projections alternate with linear and branching portions, these including each of full length portions 616, 618, 620, et. seq., from which extend smaller linear branching locations 622, 624, 626, et sq. The patterning of the branching portions or sections define a repeating “Y” pattern which, in combination with the subset pluralities of distributed dimples, operate to avoid different fluid flows at different temperatures (hot/cold) during transfer through the conductive plates, as well as to optionally provide additional flow throttling or interruption of the fluid as it travels through the disk package network between the inlet 606 and outlet 608. Without limitation, is it envisioned that other non-limiting arrangements of fluid flow and throttling patterns can be integrated into each conductive disk package in order to optimize the desired fluid thermal transfer characteristics.

It is further again noted, without limitation, that the invention contemplates in one non-limiting embodiment having all of the conductive packages concurrently circulating and heating/chilling fluid from a common line (such as previously identified at 82) in order to provide a steady and pressurized flow of conditioned fluid through the outlet. Additional non-limiting variants further envision the ability to utilize appropriate valves or controls in order to selectively activate/deactivate fluid flow through some or all of the disk packages in order to modify the volume of conditioned fluid being delivered from the fluid heater/chiller assembly, such further contemplating engaging or disengaging the rotation of the magnetic plates if the disk packages are active or inactive and connecting or disconnecting an electric supply, as well as varying intensity by increasing or decreasing power supply to the electromagnets of the disk packages that are active and engaged, if electromagnets are used, via the motor or other rotary inducing input RPM or rotational speed to accomplish best performance in terms of efficiency or COP (coefficient of performance). It is also envisioned that the associated valving/controls can be further designed in order to successively pass conditioned fluid through multiple (including consecutive or non-consecutive) conductive disk packages, such as in order to modify a desired fluid delivery temperature.

As previously described, other and additional envisioned applications can include adapting the present technology for use in magnetocaloric heat pump (MHG) applications, such utilizing a magneto-caloric effect (MCE) provide either of heating or cooling properties resulting from the magnetization (heat) or demagnetization (cold) cycles. The goal in such applications is to achieve a coefficient of performance (defined as a ratio of useful heating or cooling provided to work required) which is greater than 1.0. In such an application, the system operates to convert work to heat as well as additionally pumping heat from a heat source to where the heat is required (and factoring in all power consuming auxiliaries). As is further known in the relevant technical art, increasing the COP (such as potentially to a range of 2.0-3.5 or upwards) further results in significantly reduced operating costs in relation to the relatively small input electrical cost required for rotating the conductive plate(s) relative to the magnetic plate(s). Such magnetic refrigeration techniques result in a cooling technology based on the magneto-caloric effect and which can be used to attain extremely low temperatures within ranges used in common refrigerators, such as without limitation in order to reconfigure the present system as a water chiller.

As is further known in the relevant technical art, the magneto-caloric effect is a magneto-thermodynamic phenomenon in which a temperature change of a suitable material is again caused by exposing the material to a changing magnetic field, such being further known by low temperature physicists as adiabatic (defined as occurring without gain or loss of heat) demagnetization. In that part of the refrigeration process, a decrease in the strength of an externally applied magnetic field allows the magnetic domains of a magneto-caloric material to become disoriented from the magnetic field by the agitating action of the thermal energy (phonons) present in the material.

If the material is isolated so that no energy is allowed to (re)migrate into the material during this time, (i.e., again the adiabatic process) the temperature drops as the domains absorb the thermal energy to perform their reorientation. The randomization of the domains occurs in a similar fashion to the randomization at the curie temperature of a ferromagnetic, paramagnetic or diamagnetic material, except that magnetic dipoles overcome a decreasing external magnetic field while energy remains constant, instead of magnetic domains being disrupted from internal ferromagnetism (or paramagnetism) as energy is added. Applications of this technology can include, in one non-limited application, the ability to heat a suitable alloy arranged inside of a magnetic field as is known in the relevant technical art, causing it to lose thermal energy to the surrounding environment which then exists the field cooler than when it entered.

Other envisioned applications include the ability to generate heat for conditioning the water utilizing either individually or in combination rare earth magnets placed into a high frequency oscillating magnetic field as well as static electromagnetic field source systems including such as energized electromagnet assemblies which, in specific instances, can be combined together within a suitable assembly not limited to that described and illustrated herein and for any type of electric induction, electromagnetic and magnetic induction application. It is further envisioned that the present assembly can be applied to any material which is magnetized, such including any of diamagnetic, paramagnetic, and ferromagnetic materials without exemption also referred to as magnetocaloric materials (MEMs).

Additional factors include the ability to reconfigure the assembly so that the frictionally heated fluid existing between the overlapping rotating magnetic and stationary fluid communicating conductive plates may also include the provision of additional fluid mediums (both gaseous and liquid state) for better converting the heat or cooling configurations disclosed herein. Other envisioned applications can include the provision of capacitive and resistance (ohmic power loss) designs applicable to all materials/different configurations as disclosed herein.

The present invention also envisions, in addition to the assembly as shown and described, the provision of any suitable programmable or software support mechanism, such as including a variety of operational modes. Such can include an Energy Efficiency Mode: step threshold function at highest COP (at establish motor drive rpm) vs Progressive Control Mode: ramp-up curve at different rpm/COPs).

Other heat/cooling adjustment variables can involve modifying the degree of magnetic friction created, such as by varying the distance between the conductive fluid circulating disk packages and alternating arranged magnetic/electromagnetic plates. A further variable can include limiting the exposure of the conductive fluid (gas, liquid, etc.,) to the conductive component/linearly spaced disk packages, such that a no flow condition may result in raising the temperature (and which can be controllable for certain periods of time).

As is further generally understood in the technical art, temperature is limited to Curie temperature, with magnetic properties associated with losses above this temperature. Accordingly, rare earth magnets, including such as neodymium magnets, can achieve temperature ranges upwards of 900° C. to 1000° C.

Ferromagnetic, paramagnetic or diamagnetic Materials, such as again which can be integrated into the conductive plates, can include any of Iron (Fe) having a Curie temperature of 1043K (degrees Kelvin), Cobalt (Co) having a Curie temperature of 1400K, Nickel (Ni) having a Curie temperatures of 627K and Gadolinium (Gd) having a Curie temperature of 292K.

According to these teachings, Curie point, also called Curie Temperature, defines a temperature at which certain magnetic materials undergo a sharp change in their magnetic properties. In the case of rocks and minerals, remanent magnetism appears below the Curie point—about 570° C. (1,060° F.) for the common magnetic mineral magnetite. Below the Curie point—by non-limiting example, 770° C. (1,418° F.) for iron—atoms that behave as tiny magnets spontaneously align themselves in certain magnetic materials.

In ferromagnetic materials, such as pure iron, the atomic magnets are oriented within each microscopic region (domain) in the same direction, so that their magnetic fields reinforce each other. In antiferromagnetic materials, atomic magnets alternate in opposite directions, so that their magnetic fields cancel each other. In ferrimagnetic materials, the spontaneous arrangement is a combination of both patterns, usually involving two different magnetic atoms, so that only partial reinforcement of magnetic fields occurs.

Given the above, raising the temperature to the Curie point for any of the materials in these three classes entirely disrupts the various spontaneous arrangements, and only a weak kind of more general magnetic behaviour, called paramagnetism, remains. As is further known, one of the highest Curie points is 1,121° C. (2,050° F.) for cobalt. Temperature increases above the Curie point produce roughly similar patterns of decreasing paramagnetism in all three classes of materials such that, when these materials are cooled below their Curie points, magnetic atoms spontaneously realign so that the ferromagnetism, antiferromagnetism, or ferrimagnetism revives. As is further known, the antiferromagnetic Curie point is also referenced as the Neel temperature.

Other factors or variable controlling the temperature output can include the strength of the magnets or electromagnets which are incorporated into the plates, such as again by selected rare earth magnets having varying properties or, alternatively, by adjusting the factors associated with the use of electromagnets including an amount of current through the coils, adjusting the core ferromagnetic properties (again though material selection) or by adjusting the cold winding density around the associated core.

Other temperature adjustment variables can include modifying the size, number, location and orientation of the assemblies (elongated and plural magnet/electromagnet and alternative conductive plates). Multiple units or assemblies can also be stacked, tiered or otherwise ganged in order to multiply a given volume of conditioned fluid which is produced.

Additional variables can include varying the designing of the conductive disk packages, such as not limited varying a thickness, positioning or configuration of a blade or other fluid flow redirecting profile integrated into the conductive plates, as well as utilizing the varying material properties associated with different metals or alloys, such including ferromagnetic, paramagnetic and diamagnetic properties.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

I claim:

1. A fluid conditioning system, comprising:
a housing having a fluid inlet;
a sleeve shaped support extending within said housing;
a plurality of spaced apart magnetic or electromagnetic plates communicated with said fluid inlet, said plates extending radially from said sleeve support;
an elongated conductive component supported about said sleeve support, said conductive component incorporating a plurality of linearly spaced apart and radially projecting fluid communicating packages which alternate in arrangement with said axially spaced and radially supported magnetic/electromagnetic plates;
a conduit extending from said fluid inlet to a fluid outlet of said housing, each of said fluid communicating packages including individual inlet and outlet locations to said conduit; and
a motor for rotating said sleeve support and magnetic/electromagnetic plates to generate an oscillating magnetic field, resulting in conditioning of the fluid circulated within each fluid communicating package by either heating or cooling of the fluid.

2. The invention of claim 1, each of said fluid communicating package including a pair of conductive plates which, upon being assembled together, define an interior pathway extending between said inlet and outlet locations of said package.

3. The invention of claim 2, said interior pathway further comprising a plurality of radially extending individual lengths interconnected end to end in a circumferential ribbon fashion about an interior circumference of the assembled package.

4. The invention of claim 2, said interior pathway further comprising any dimpled or irregular pattern extending between each of said inlet and outlet locations and arranged in radial and reverse-bended locations extending in progressing fashion about the interior circumference of the assembled package.

5. The invention of claim 2, said interior pathway further comprising alternating combinations of dimples with each of linear and “Y” branching portions for avoiding different fluid flow at different temperatures for transfer through said conductive plates.

6. The invention of claim 2, said interior pathway further comprising a plurality of individual spiraling lengths interconnected end to end in a circumferential reverse bended fashion about an interior circumference of the assembled package.

7. The invention of claim 3, said radially extending lengths further comprising individually tapered profiles to create a wave effect on the circulated fluid.

8. The invention of claim 2, further comprising a plurality of agitating elements positioned within the interior pathway for interrupting the fluid circulating flow within each conductive package.

9. The invention as described in claim 1, said magnetic or electromagnetic plates and said conductive packages each further comprising a circular shape.

10. The invention as described in claim 1, further comprising said fluid communicating packages being combined into individual pairs.

11. The invention as described in claim 1, further comprising said system providing production of on demand conditioned fluid without need of a holding tank.

12. The invention as described in claim 1, further comprising said motor or other rotary inducing input selectively activating or deactivating any sub-plurality of magnetic or electromagnetic plates alternating given fluid communicating packages.

13. The invention as described in claim 1, further comprising any sub-plurality of said fluid communicating packages being deactivated through valving associated with each of said individual fluid inlet and outlet locations.

14. The invention as described in claim 1, further comprising said fluid communicating packages being provided in individual pairs, an intermediate plate separating a pair of sub-plates associated with each pair of individual fluid communicating packages.

15. The invention as described in claim 14, further comprising a first of said sub-plates directing fluid in a first circuitous and circumferential direction, said intermediate plate communicating an outlet of said first sub-plate to an inlet of said second sub-late for redirecting fluid flow in a second counter direction.

16. The invention as described in claim 1, further comprising a central shaft secured to said sleeve-shaped support via radially extending brackets for rotating said plurality of magnetic or electromagnetic plates.

17. The invention as described in claim 16, further comprising said motor or other rotary inducing input being located within said sleeve extending within said housing for rotating a central shaft connected to said sleeve via radially extending brackets.

18. The invention as described in claim 16, further comprising said motor or other rotary inducing input located outside of said housing for rotating a central shaft connected to said sleeve via radially extending brackets.

19. The invention as described in claim 1, further comprising said motor or other rotary inducing input selectively engaging or disengaging sub-pluralities of said magnetic/electromagnetic plates to corresponding with fluid activated fluid communicating packages.

20. The invention as described in claim 1, further comprising a power supply to said motor or other rotary inducting input being selectively increased or decreased in order to adjust a speed of rotation of said magnetic/electromagnetic plates.
